(19) United States
(12) Patent Application Publication
(10) Pub. No.: US 2019/0141323 A1
(43) Pub. Date: May 9, 2019

(54) VIDEO IMAGE ENCODING METHOD AND APPARATUS, AND VIDEO IMAGE DECODING METHOD AND APPARATUS

(71) Applicants: Huawei Technologies Co., Ltd., Shenzhen (CN); University of Science and Technology of China, Hefei (CN)

(72) Inventors: Haitao YANG, Shenzhen (CN); Li LI, Hefei (CN); Houqiang LI, Hefei (CN)

(21) Appl. No.: 16/220,749

(22) Filed: Dec. 14, 2018

Related U.S. Application Data
(63) Continuation of application No. PCT/CN2017/088024, filed on Jun. 13, 2017.

(30) Foreign Application Priority Data
Jun. 16, 2016 (CN) 201610430405.8

(51) Int. Cl. H04N 19/119; H04N 19/44; H04N 19/59; H04N 19/80; H04N 19/33

(52) U.S. Cl. CPC H04N 19/119; H04N 19/44; H04N 19/33; H04N 19/80; H04N 19/59

(57) ABSTRACT

A video image decoding method includes: parsing a high-resolution image bitstream, to generate a reconstructed image of a first-type sub-image and auxiliary information of the first-type sub-image, where the auxiliary information represents dimension information of the sub-image and position information of the sub-image in a to-be-reconstructed image, the sub-image is a pixel set of any continuous area in the to-be-reconstructed image, and sub-images of the to-be-reconstructed image do not overlap with each other; when a complete reconstructed image fails to be obtained based on the reconstructed image of the first-type sub-image, parsing a low-resolution image bitstream, to generate a reconstructed image of a second-type sub-image, where the second-type sub-image has a resolution the same as that of the first-type sub-image; and splicing the reconstructed image of the first-type sub-image and the reconstructed image of the second-type sub-image based on the auxiliary information, to generate the reconstructed image.

### CROSS-REFERENCE TO RELATED APPLICATIONS

This application is a continuation of International Application No. PCT/CN2017/088024, filed on Jun. 13, 2017, which claims priority to Chinese Patent Application No. 201610430405.8, filed on Jun. 16, 2016. The disclosures of the aforementioned applications are hereby incorporated by reference in their entireties.

### STATEMENT OF JOINT RESEARCH AGREEMENT

The subject matter of the present application was made by or on the behalf of University of Science and Technology of China, of Baohe District, Hefei, Anhui Province, P.R. China and Huawei Technologies Co., Ltd., of Shenzhen, Guangdong Province, P.R. China, under a joint research agreement titled “Research and Development of Next Generation Video Coding Standards and Technologies.” The joint research agreement was in effect on or before the subject matter of the present application was made, and the subject matter of the present application was made as a result of activities undertaken within the scope of the joint research agreement.

### TECHNICAL FIELD

Embodiments of the present application relate to the field of video image compression, and in particular, to a video image encoding method and apparatus, and a video image decoding method and apparatus.

### BACKGROUND

With the rapid popularity of a series of virtual reality (VR) products and applications such as virtual reality glasses (Oculus Rift) and a virtual reality headset (Gear VR), browsing video content or performing a real-time video conversation by using a VR product becomes one of important applications of the VR product.

A common form of a VR terminal device is a head-mounted viewing device, and is usually a pair of glasses. A light-emitting screen is built in to display a video image. A position and direction sensing system is disposed inside the device, and can track various motions of a head of a user, and present video image content in a corresponding position and direction to the screen. The VR terminal device may further include an advanced interactive functional module such as a user eye tracking system, and present a user-interested area to the screen. To support presentation of video image content in all directions, a VR video image needs to include 360-degree omnidirectional visual information of three-dimensional space. This may be imagined as viewing a map on a terrestrial globe from an inner central position of the terrestrial globe. Therefore, the VR video image may also be referred to as a panoramic video image.

A video image may be understood as an image sequence of images that are collected at different moments. Because object movement is continuous in a time-space domain, content of adjacent images in the image sequence has high similarity. Therefore, various processing on a video may also be decomposed into corresponding processing performed separately on images in the video.

If the panoramic video image is in a spherical format, the panoramic video image cannot be conveniently represented, stored, or retrieved by using an index. Therefore, in the prior art, a spherical panorama is usually expanded to obtain a two-dimensional planar panorama, and then operations such as compression, processing, storage, and transmission are performed on the two-dimensional planar panorama. An operation of expanding the three-dimensional spherical panorama to obtain the two-dimensional planar panorama is referred to as mapping. Currently, there are a plurality of mapping methods, and a plurality of two-dimensional planar panorama formats are obtained correspondingly. The most common panorama format is referred to as a longitude-latitude map, and the longitude-latitude map may be visually represented as FIG 1. In the longitude-latitude map. images of areas close to the north and south poles are obtained through stretching, and there is severe distortion and data redundancy.

To overcome strong distortion of the longitude-latitude map, as shown in FIG. 2, a panorama may be projected into a pyramid-shaped pentahedron, and projection of a current field of view of a user is kept on a bottom of a pyramid. In this projection manner, an image resolution of the current field of view on the bottom of the pyramid is kept unchanged, resolution reduction processing is performed on side and rear fields of view of the user that are represented by the other four faces, then the pentahedron is expanded, and deformation processing is performed on the four side faces of the pyramid, so that all five faces of the pyramid are spliced into a square image, as shown in FIG. 3. To respond to a field-of-view switching requirement of the user, a space spherical surface may be further segmented into several viewpoints, a pyramid-formatted image is generated for each viewpoint, and a pyramid-formatted panorama of the several viewpoints is stored, as shown in FIG. 4.

Therefore, to meet a requirement of a user for viewing video content of any viewpoint, a large amount of video data needs to be stored, and video data of a plurality of viewpoints needs to be encoded. This increases data processing complexity and power consumption of an encoding or decoding device, and consequently increases difficulty for real-time panoramic video communication.

### SUMMARY

Embodiments of the present application provide a video image encoding method and apparatus, and a video image decoding method and apparatus, to improve encoding efficiency.

To achieve the foregoing objective, the following technical solutions are used in embodiments of the present application.

According to a first aspect, an embodiment of the present application provides a video image encoding method, including: encoding at least one sub-image of a to-be-encoded image, to generate a high-resolution image bitstream, where the sub-image is a pixel set of any continuous area in the to-be-encoded image, and sub-images of the to-be-encoded image do not overlap with each other; and encoding auxiliary information of the at least one sub-image into the high-resolution image bitstream, where the auxiliary information represents dimension information of the sub-image and position information of the sub-image in the to-be-encoded image.

In a first feasible implementation, the encoding at least one sub-image of a to-be-encoded image, to generate a high-resolution image bitstream includes: performing downsampling on the to-be-encoded image, to generate a low-resolution image; encoding the low-resolution image, to generate a low-resolution image bitstream and a low-resolution reconstructed image; obtaining a predictor of the at least one sub-image based on the low-resolution reconstructed image, a resolution ratio between the to-be-encoded image and the low-resolution image, and the auxiliary information of the at least one sub-image; and obtaining a residual value of the at least one sub-image based on the predictor and an original pixel value of the at least one sub-image, and encoding the residual value, to generate the high-resolution image bitstream.

In a second feasible implementation, the obtaining a predictor of the at least one sub-image based on the low-resolution reconstructed image, a resolution ratio between the to-be-encoded image and the low-resolution image, and the auxiliary information of the at least one sub-image includes: performing mapping on the auxiliary information of the at least one sub-image based on the resolution ratio, to determine dimension information of a low-resolution sub-image corresponding to the at least one sub-image in the low-resolution reconstructed image and position information of the low-resolution sub-image in the low-resolution reconstructed image; and performing upsampling on the low-resolution sub-image based on the resolution ratio, to obtain the predictor of the at least one sub-image.

In a third feasible implementation, the auxiliary information includes first auxiliary information, and the first auxiliary information includes: a position offset of an upper left corner pixel of the sub-image relative to an upper left corner pixel of the to-be-encoded image and a width and a height of the sub-image, or a serial number of the sub-image in a preset arrangement sequence in the to-be-encoded image.

In a fourth feasible implementation, a slice header of a first slice of the sub-image in the high-resolution image bitstream carries the first auxiliary information.

In a fifth feasible implementation, the auxiliary information further includes second auxiliary information, and the second auxiliary information includes a mode in which the to-be-encoded image is divided into the sub-image.

In a sixth feasible implementation, a picture parameter set of the high-resolution image bitstream carries the second auxiliary information.

In a seventh feasible implementation, the resolution ratio is a preset value.

In an eighth feasible implementation, the resolution ratio is encoded into a slice header of a first slice or a picture parameter set of the low-resolution image bitstream.

In a ninth feasible implementation, a resolution of the to-be-encoded image is encoded into the high-resolution image bitstream; and a resolution of the low-resolution image is encoded into the low-resolution image bitstream.

According to a second aspect, an embodiment of the present application provides a video image decoding method, including: parsing a high-resolution image bitstream, to generate a reconstructed image of a first-type sub-image and auxiliary information of the first-type sub-image, where the auxiliary information represents dimension information of the sub-image and position information of the sub-image in a decoder to-be-reconstructed image, the sub-image is a pixel set of any continuous area in the decoder to-be-reconstructed image, and sub-images of the decoder to-be-reconstructed image do not overlap with each other; when a complete decoder reconstructed image fails to be obtained based on the reconstructed image of the first-type sub-image, parsing a low-resolution image bitstream, to generate a reconstructed image of a second-type sub-image, where the second-type sub-image has a resolution the same as that of the first-type sub-image; and splicing the reconstructed image of the first-type sub-image and the reconstructed image of the second-type sub-image based on the auxiliary information, to generate the decoder reconstructed image.

In a first feasible implementation, the parsing a high-resolution image bitstream, to generate a reconstructed image of a first-type sub-image and auxiliary information of the first-type sub-image includes parsing the high-resolution image bitstream, to obtain the auxiliary information and a residual value of the first-type sub-image in the decoder to-be-reconstructed image; obtaining a predictor of the first-type sub-image based on the low-resolution bitstream, a resolution ratio between the decoder to-be-reconstructed image and a low-resolution to-be-reconstructed image, and the auxiliary information of the first-type sub-image; and generating the reconstructed image of the first-type sub-image based on the predictor and the residual value of the first-type sub-image.

In a second feasible implementation, the obtaining a predictor of the first-type sub-image based on the low-resolution bitstream, a resolution ratio between the decoder to-be-reconstructed image and a low-resolution to-be-reconstructed image, and the auxiliary information of the first-type sub-image includes:

performing mapping on the auxiliary information of the first-type sub-image based on the resolution ratio, to determine dimension information of a first-type low-resolution sub-image corresponding to the first-type sub-image in the low-resolution to-be-reconstructed image and position information of the first-type low-resolution sub-image in the low-resolution to-be-reconstructed image;

parsing the low-resolution image bitstream, to generate the first-type low-resolution sub-image; and

performing upsampling on the first-type low-resolution sub-image based on the resolution ratio, to obtain the predictor of the first-type sub-image.

In a third feasible implementation, the parsing a low-resolution image bitstream, to generate a reconstructed image of the second-type sub-image includes: determining, based on the auxiliary information of the first-type sub-image and the resolution ratio between the decoder to-be-reconstructed image and the low-resolution to-be-reconstructed image, dimension information of a second-type low-resolution sub-image corresponding to the second-type sub-image in the low-resolution to-be-reconstructed image and position information of the second-type low-resolution sub-image in the low-resolution to-be-reconstructed image; parsing the low-resolution image bitstream, to generate the second-type low-resolution sub-image; and performing upsampling on the second-type low-resolution sub-image based on the resolution ratio, to generate the reconstructed image of the second-type sub-image.

In a fourth feasible implementation, the auxiliary information includes first auxiliary information, and the first auxiliary information includes: a position offset of an upper left corner pixel of the sub-image relative to an upper left corner pixel of the decoder to-be-reconstructed image and a width and a height of the sub-image, or a serial number of the sub-image in a preset arrangement sequence in the decoder to-be-reconstructed image.

In a fifth feasible implementation, a slice header of a first slice of the sub-image in the high-resolution image bitstream carries the first auxiliary information.

In a sixth feasible implementation, the auxiliary information further includes second auxiliary information, and the second auxiliary information includes a mode in which the decoder to-be-reconstructed image is divided into the sub-image.

In a seventh feasible implementation, a picture parameter set of the high-resolution image bitstream carries the second auxiliary information.

In an eighth feasible implementation, the resolution ratio is a preset value.

In a ninth feasible implementation, a slice header of a first slice or a picture parameter set of the low-resolution image bitstream is parsed to obtain the resolution ratio.

In a tenth feasible implementation, the high-resolution image bitstream is parsed to obtain a resolution of the decoder to-be-reconstructed image; and the low-resolution image bitstream is parsed to obtain a resolution of the low-resolution to-be-reconstructed image.

According to a third aspect, an embodiment of the present application provides a video image encoding apparatus, including: a first encoding module, configured to encode at least one sub-image of a to-be-encoded image, to generate a high-resolution image bitstream, where the sub-image is a pixel set of any continuous area in the to-be-encoded image, and sub-images of the to-be-encoded image do not overlap with each other; and a second encoding module, configured to encode auxiliary information of the at least one sub-image into the high-resolution image bitstream, where the auxiliary information represents dimension information of the sub-image and position information of the sub-image in the to-be-encoded image.

In a first feasible implementation, the first encoding module includes: a downsampling module, configured to perform downsampling on the to-be-encoded image, to generate a low-resolution image; a third encoding module, configured to encode the low-resolution image, to generate a low-resolution image bitstream and a low-resolution reconstructed image; a prediction module, configured to obtain a predictor of the at least one sub-image based on the low-resolution reconstructed image, a resolution ratio between the to-be-encoded image and the low-resolution image, and the auxiliary information of the at least one sub-image; and a fourth encoding module, configured to: obtain a residual value of the at least one sub-image based on the predictor and an original pixel value of the at least one sub-image, and encode the residual value, to generate the high-resolution image bitstream.

In a second feasible implementation, the prediction module includes: a determining module, configured to perform mapping on the auxiliary information of the at least one sub-image based on the resolution ratio, to determine dimension information of a low-resolution sub-image corresponding to the at least one sub-image in the low-resolution reconstructed image and position information of the low-resolution sub-image in the low-resolution reconstructed image; and an upsampling module, configured to perform upsampling on the low-resolution sub-image based on the resolution ratio, to obtain the predictor of the at least one sub-image.

In a third feasible implementation, the auxiliary information includes first auxiliary information, and the first auxiliary information includes: a position offset of an upper left corner pixel of the sub-image relative to an upper left corner pixel of the to-be-encoded image and a width and a height of the sub-image, or a serial number of the sub-image in a preset arrangement sequence in the to-be-encoded image.

In a fourth feasible implementation, a slice header of a first slice of the sub-image in the high-resolution image bitstream carries the first auxiliary information.

In a fifth feasible implementation, the auxiliary information further includes second auxiliary information, and the second auxiliary information includes a mode in which the to-be-encoded image is divided into the sub-image.

In a sixth feasible implementation, a picture parameter set of the high-resolution image bitstream carries the second auxiliary information.

According to a fourth aspect, an embodiment of the present application provides a video image decoding apparatus, including: a first parsing module, configured to parse a high-resolution image bitstream, to generate a reconstructed image of a first-type sub-image and auxiliary information of the first-type sub-image, where the auxiliary information represents dimension information of the sub-image and position information of the sub-image in a decoder to-be-reconstructed image, the sub-image is a pixel set of any continuous area in the decoder to-be-reconstructed image, and sub-images of the decoder to-be-reconstructed image do not overlap with each other; a second parsing module, configured to: when a complete decoder reconstructed image fails to be obtained based on the reconstructed image of the first-type sub-image, parse a low-resolution image bitstream, to generate a reconstructed image of a second-type sub-image, where the second-type sub-image has a resolution the same as that of the first-type sub-image; and a splicing module, configured to splice the reconstructed image of the first-type sub-image and the reconstructed image of the second-type sub-image based on the auxiliary information, to generate the decoder reconstructed image.

In a first feasible implementation, the first parsing module includes: a third parsing module, configured to parse the high-resolution image bitstream, to obtain the auxiliary information and a residual value of the first-type sub-image in the decoder to-be-reconstructed image; a prediction module, configured to obtain a predictor of the first-type sub-image based on the low-resolution bitstream, a resolution ratio between the decoder to-be-reconstructed image and a low-resolution to-be-reconstructed image, and the auxiliary information of the first-type sub-image; and a reconstruction module, configured to generate the reconstructed image of the first-type sub-image based on the predictor and the residual value of the first-type sub-image.

In a second feasible implementation, the prediction module includes: a first determining module, configured to perform mapping on the auxiliary information of the first-type sub-image based on the resolution ratio, to determine dimension information of a first-type low-resolution sub-image corresponding to the first-type sub-image in the low-resolution to-be-reconstructed image and position information of the first-type low-resolution sub-image in the low-resolution to-be-reconstructed image; a fourth parsing module, configured to parse the low-resolution image bitstream, to generate the first-type low-resolution sub-image; and a first upsampling module, configured to perform upsampling on the first-type low-resolution sub-image based on the resolution ratio, to obtain the predictor of the first-type sub-image.

In a third feasible implementation, the second parsing module includes: a second determining module, configured to determine, based on the auxiliary information of the first-type sub-image and the resolution ratio between the decoder to-be-reconstructed image and the low-resolution to-be-reconstructed image, dimension information of a second-type low-resolution sub-image corresponding to the second-type sub-image in the low-resolution to-be-reconstructed image and position information of the second-type low-resolution sub-image in the low-resolution to-be-reconstructed image; a fifth parsing module, configured to parse the low-resolution image bitstream, to generate the second-type low-resolution sub-image; and a second upsampling module, configured to perform upsampling on the second-type low-resolution sub-image based on the resolution ratio, to generate the reconstructed image of the second-type sub-image.

In a fourth feasible implementation, the auxiliary information includes first auxiliary information, and the first auxiliary information includes: a position offset of an upper left corner pixel of the sub-image relative to an upper left corner pixel of the decoder to-be-reconstructed image and a width and a height of the sub-image, or a serial number of the sub-image in a preset arrangement sequence in the decoder to-be-reconstructed image.

In a fifth feasible implementation, a slice header of a first slice of the sub-image in the high-resolution image bitstream carries the first auxiliary information.

In a sixth feasible implementation, the auxiliary information further includes second auxiliary information, and the second auxiliary information includes a mode in which the decoder to-be-reconstructed image is divided into the sub-image.

In a seventh feasible implementation, a picture parameter set of the high-resolution image bitstream carries the second auxiliary information.

According to a fifth aspect, an embodiment of the present application provides a video image encoding apparatus, including: a memory and a processor coupled to the memory, where the memory is configured to store code and an instruction; and the processor is configured to perform the following steps according to the code and the instruction: encoding at least one sub-image of a to-be-encoded image, to generate a high-resolution image bitstream, where the sub-image is a pixel set of any continuous area in the to-be-encoded image, and sub-images of the to-be-encoded image do not overlap with each other; and encoding auxiliary information of the at least one sub-image into the high-resolution image bitstream, where the auxiliary information represents dimension information of the sub-image and position information of the sub-image in the to-be-encoded image.

In a first feasible implementation, the processor is specifically configured to: perform downsampling on the to-be-encoded image, to generate a low-resolution image; encode the low-resolution image, to generate a low-resolution image bitstream and a low-resolution reconstructed image; obtain a predictor of the at least one sub-image based on the low-resolution reconstructed image, a resolution ratio between the to-be-encoded image and the low-resolution image, and the auxiliary information of the at least one sub-image; and obtain a residual value of the at least one sub-image based on the predictor and an original pixel value of the at least one sub-image, and encode the residual value, to generate the high-resolution image bitstream.

According to a sixth aspect, an embodiment of the present application provides a video image decoding apparatus, including: a memory and a processor coupled to the memory, where the memory is configured to store code and an instruction; and the processor is configured to perform the following steps according to the code and the instruction: parsing a high-resolution image bitstream, to generate a reconstructed image of a first-type sub-image and auxiliary information of the first-type sub-image, where the auxiliary information represents dimension information of the sub-image and position information of the sub-image in a decoder to-be-reconstructed image, the sub-image is a pixel set of any continuous area in the decoder to-be-reconstructed image, and sub-images of the decoder to-be-reconstructed image do not overlap with each other; when a complete decoder reconstructed image fails to be obtained based on the reconstructed image of the first-type sub-image, parsing a low-resolution image bitstream, to generate a reconstructed image of a second-type sub-image, where the second-type sub-image has a resolution the same as that of the first-type sub-image; and splicing the reconstructed image of the first-type sub-image and the reconstructed image of the second-type sub-image based on the auxiliary information, to generate the decoder reconstructed image.

According to a seventh aspect, an embodiment of the present application provides a computer-readable storage medium that stores an instruction, and when the instruction is executed, one or more processors of a device for encoding video image data are used to perform the method in the first aspect and feasible implementations of the first aspect.

According to an eighth aspect, an embodiment of the present application provides a computer-readable storage medium that stores an instruction, and when the instruction is executed, one or more processors of a device for decoding video image data are used to perform the method in the second aspect and feasible implementations of the second aspect.

It should be understood that, in embodiments of the present application, application concepts of the third, the fifth, and the seventh aspects are consistent with those of the first aspect, and the technical solutions of the third, the fifth, and the seventh aspects are similar to those of the first aspect; and application concepts of the fourth, the sixth, and the eighth aspects are consistent with those of the second aspect, and the technical solutions of the fourth, the sixth, and the eighth aspects are similar to those of the second aspect. For beneficial effects of the solutions of the third, the fifth, and the seventh aspects and feasible implementations, and beneficial effects of the solutions of the fourth, the sixth, and the eighth aspects in embodiments of the present application and feasible implementations, refer to related content of the first aspect and the second aspect, and details are not described herein again.

### BRIEF DESCRIPTION OF DRAWINGS

To describe technical solutions in embodiments of the present application more clearly, the following briefly describes the accompanying drawings. It will be appreciated that the accompanying drawings in the following description show merely some embodiments of the present application, and a person of ordinary skill in the art may still derive other drawings from these accompanying drawings without creative efforts.

FIG. 1 is a schematic diagram of longitude-latitude map mapping according to an embodiment of the present application.

FIG. 2 is a schematic diagram of a pyramid-formatted panorama according to an embodiment of the present application;

FIG. 3 is a schematic diagram of a pyramid-formatted projection process according to an embodiment of the present application;

FIG. 4 is a schematic diagram of a multi-view pyramid-formatted panorama according to an embodiment of the present application;

FIG. 5 is a schematic diagram of a VR video image content end-to-end system according to an embodiment of the present application;

FIG. 6 is a schematic flowchart of a video image encoding method according to an embodiment of the present application;

FIG. 7 is a schematic diagram of a manner for obtaining a sub-image through division according to an embodiment of the present application;

FIG. 8 (a) is a schematic diagram of another manner for obtaining a sub-image through division according to an embodiment of the present application;

FIG. 8 (b) is a schematic diagram of still another manner for obtaining a sub-image through division according to an embodiment of the present application;

FIG. 9 is a schematic diagram of a manner of representing position information and dimension information of a sub-image according to an embodiment of the present application;

FIG. 10 is a schematic diagram of a sub-image serial number representation manner according to an embodiment of the present application;

FIG. 11 is a schematic diagram of another sub-image serial number representation manner according to an embodiment of the present application;

FIG. 12 is a schematic diagram of another sub-image serial number representation manner according to an embodiment of the present application;

FIG. 13 is a schematic flowchart of a video image decoding method according to an embodiment of the present application;

FIG. 14 is a schematic block diagram of a video image encoding apparatus according to an embodiment of the present application;

FIG. 15 is a schematic block diagram of a video image decoding apparatus according to an embodiment of the present application;

FIG. 16 is a schematic block diagram of a video image encoding apparatus according to an embodiment of the present application; and

FIG. 17 is a schematic block diagram of a video image decoding apparatus according to an embodiment of the present application.

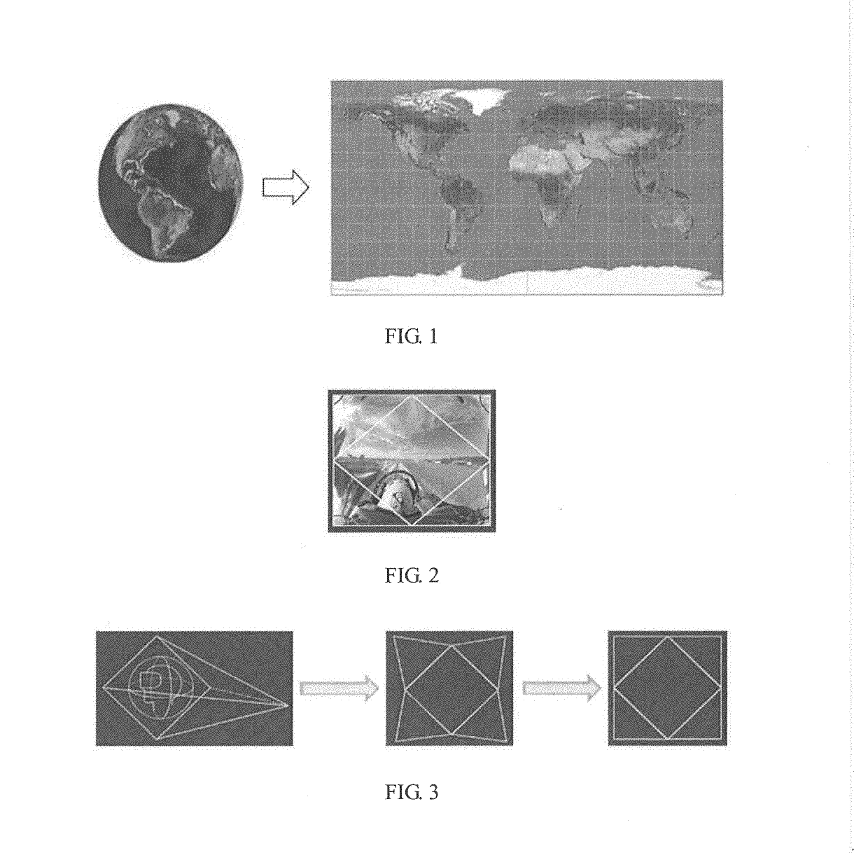

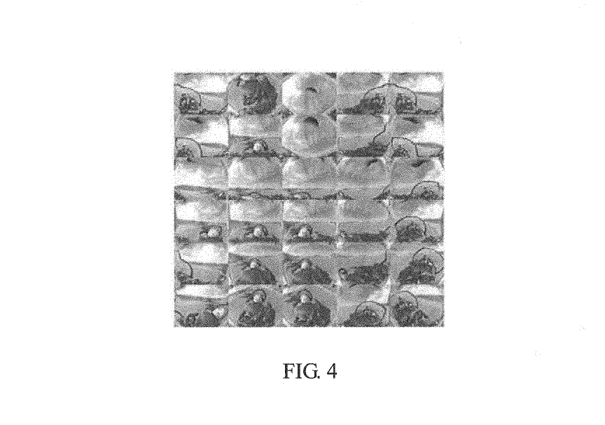

### DESCRIPTION OF EMBODIMENTS

The following clearly describes technical solutions in embodiments of the present application with reference to the accompanying drawings. It will be appreciated that the described embodiments are merely some but not all of the embodiments of the present application.

In the prior art, to adaptively obtain and play content of a corresponding field of view based on a viewing angle of a user, pyramid-formatted video content of all viewpoints need to be stored at a server end. This increases panoramic video storage overheads by times. In addition, a server needs to encode pyramid-formatted video content of all fields of view and then store encoded content. This increases VR video encoding complexity and power consumption by times. Consequently, real-time encoding and transmission of panoramic video content cannot be implemented because complexity is excessively high. In a technical solution for encoding and decoding a panoramic video image in the present application, a part of content in a to-be-encoded image is selectively encoded, and at a decoder, a reconstructed image of a to-be-encoded image of an original-resolution version is adaptively generated based on a reconstructed image of a to-be-encoded image of a low-resolution version. This may reduce both encoding complexity and decoding complexity, and reduce panoramic video transmission bandwidth, so that real-time panoramic video communication may be implemented. In addition, the solution in the present application may further significantly reduce the panoramic video storage overheads, so that large-scale deployment of a panoramic video streaming media service may be implemented.

To facilitate clear description of technical solutions in embodiments of the present application, words such as “first”, “second”, and “third” are used in the embodiments of the present application to distinguish between same items or similar items that provide basically same functions or purposes. A person skilled in the art may understand that the words such as “first”, “second”, and “third” do not limit a quantity and an execution sequence.

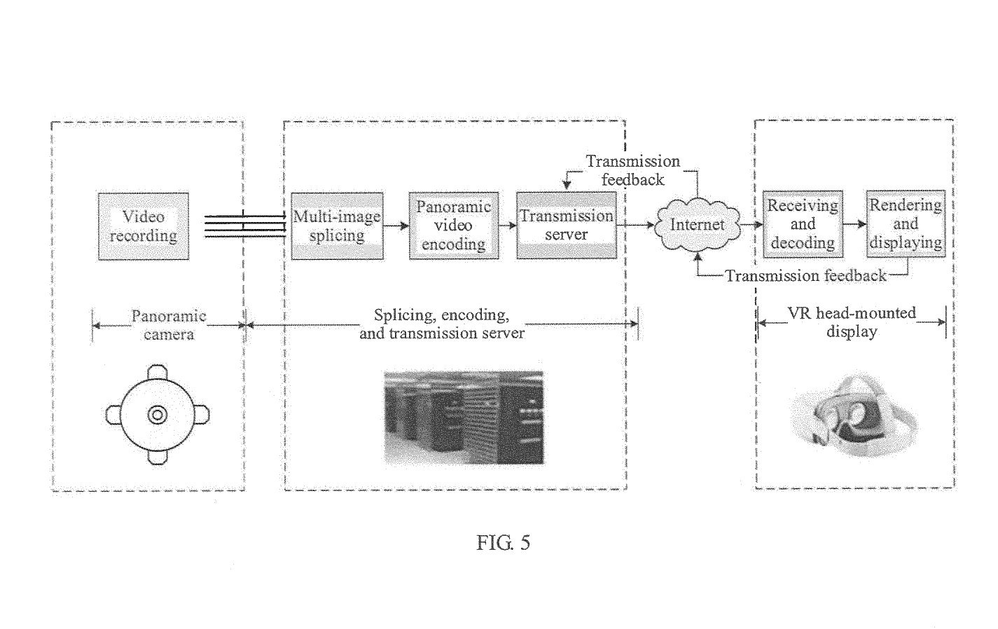

FIG. 5 is a schematic diagram of a VR video image content end-to-end system according to an embodiment of the present application. The VR video image content end-to-end system includes a collection module, a splicing module, an encoding module, a transmission module, a decoding module, and a display module. In an application, based on orientation information sent by a corresponding user, a server needs to transmit found video image content of a corresponding viewpoint to the user in real time. In another application, VR content may be distributed to a user in a file form, and the user reads a VR content file from a medium such as a magnetic disk, and decodes and displays the VR content file.

An existing VR video image collection device is usually an annular multi-camera array or a spherical multi-camera array, and each camera collects images at different angles to obtain a multi-view video image in a current scenario. Then, image splicing is performed on the multi-view video image to obtain a three-dimensional spherical panorama, and then mapping is performed on the three-dimensional spherical panorama to obtain a two-dimensional planar panorama, used for input of subsequent operations such as processing, compression, transmission, and storage.

An existing VR video image display device is usually a head-mounted viewing device, and a two-dimensional planar panorama is entered into the VR video image display device. The VR display device projects a corresponding part of the two-dimensional planar panorama on a three-dimensional spherical surface based on a current viewing angle of a user, and presents the corresponding part to the user. The entered two-dimensional planar panorama may be received in real time, or may be read from a stored file. The entered two-dimensional planar panorama may have undergone operations such as image processing and compression.

User experience study indicates that, to achieve relatively high image quality, a spatial resolution of a two-dimensional planar panorama needs to reach 11520×5760, and this exceeds an 8K video resolution. However, limited by a decoding capability and a resolution of a display screen, a resolution of a panorama in an existing VR product is only 2K.

The solution of the present application relates to encoding and decoding operations of a two-dimensional planar panorama, but a data format of a panorama is not limited. For ease of description, the following uses a longitude-latitude map as an example for description. However, the solution of the present application may also be applied to two-dimensional planar panoramas in various formats such as a hexahedron, an annulus, and a polyhedron.

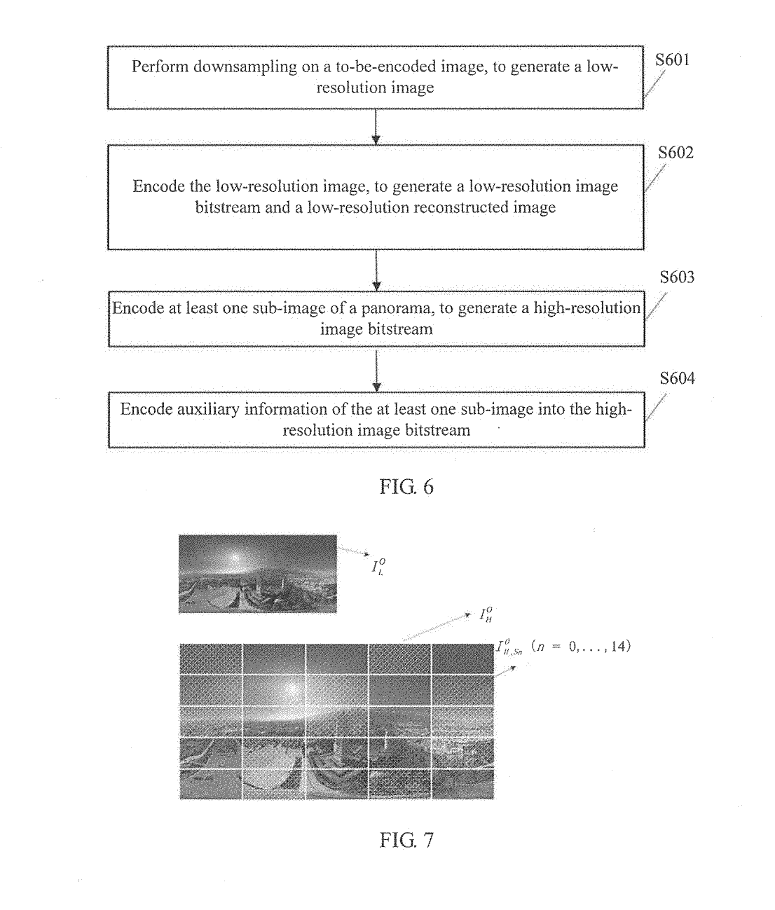

As shown in FIG. 6, an embodiment of the present application provides a video image encoding method.

S601. Perform downsampling on a to-be-encoded image, to generate a low-resolution image.

It is assumed that the to-be-encoded image in this embodiment of the present application is a panorama I_{H}^{O}, and a low-resolution image, that is, a low-resolution version panorama I_{L}^{O} is generated, as shown in FIG. 7.

Reducing a resolution of an image is usually referred to as downsampling performed on the image. In a feasible implementation, downsampling may be performed on the to-be-encoded image based on an integral-multiple ratio such as 2:1 or 4:1, or based on a fractional-multiple ratio such as 3:2 or 4:3, and no limitation is imposed. The multiple ratio is a ratio of a resolution of the to-be-encoded image to a resolution of the low-resolution image obtained through downsampling. In a feasible implementation, the multiple ratio may be preset; and in another feasible implementation, during encoding, the multiple ratio may be manually set depending on a requirement for transmission bandwidth or video image quality, and no limitation is imposed. A typical integral-multiple-ratio downsampling operation includes low-pass filtering performed on a signal and then extracting of an original sampling signal at intervals based on a specific multiple ratio, to obtain a downsampling signal, where various low-pass filters such as a Gaussian filter and a bilateral filter may be used. A typical fractional-multiple-ratio downsampling operation includes an interpolation operation performed in a specified sampling position by using a preset interpolation filter, to obtain a downsampling signal, where various interpolation filters such as a bilinear filter and a bicubic filter may be used. Different downsampling methods are used in different embodiments, to obtain a low-resolution panorama, and no limitation is imposed on a specific downsampling method.

S602. Encode the low-resolution image, to generate a low-resolution image bitstream and a low-resolution reconstructed image.

In this embodiment of the present application, compression and encoding is performed on I_{L}^{O}, to generate a compressed bitstream of I_{L}^{O} and obtain a reconstructed image of I_{L}^{K} of I_{L}^{O}. In a feasible implementation, compression and encoding may be performed on I_{L}^{O} by using any known video or image compression and encoding method, for example, a video coding standard H.265 or H.264, or a video image encoding method specified in standards such as a Joint Photographic Experts Group (JPEG) image encoding standard, or by using an intra-frame coding method, or by using an interframe coding method, and no limitation is imposed.

In a feasible implementation, a decoder needs to know the downsampling multiple ratio described in S601. In a feasible implementation, an encoder and the decoder agree on the downsampling multiple ratio without encoding or information transmission between the encoder and the decoder. For example, the downsampling multiple ratio may be a specified value, or there is a preset mapping relationship between the downsampling multiple ratio and an attribute such as the resolution of the to-be-encoded image, and no limitation is imposed. In a feasible implementation, the downsampling multiple ratio is encoded and transmitted. For example, the downsampling multiple ratio of I_{L}^{O} may be carried in a slice header of a first slice or carried in a picture parameter set (PPS), and no limitation is imposed. In a feasible implementation, the resolution of the to-be-encoded image and the resolution of the low-resolution image are respectively encoded into a high-resolution image bitstream and the low-resolution image bitstream in respective bitstream encoding processes, and the decoder may obtain the downsampling multiple ratio by separately parsing the high-resolution image bitstream and the low-resolution image bitstream and comparing a resolution of a high-resolution image and the resolution of the low-resolution image that are obtained through parsing.

S603. Encode at least one sub-image of a panorama, to generate a high-resolution image bitstream.

It should be understood that, in this embodiment of the present application, the to-be-encoded panorama may be divided into several sub-images, where a sub-image is a pixel set of any continuous area in the to-be-encoded image, sub-images do not overlap with each other, a sub-image may be a pixel or a plurality of pixels, and no limitation is imposed. For example, the pixel set may be a rectangular pixel block, such as a pixel block of 256×256 or 1024×512.

It should be understood that, boundary expansion processing may be performed in advance on the panorama in this embodiment of the present application, so that the panorama can be divided into an integral quantity of sub-images. Boundary expansion processing is a common processing operation of video image encoding and decoding, and details are not described herein.

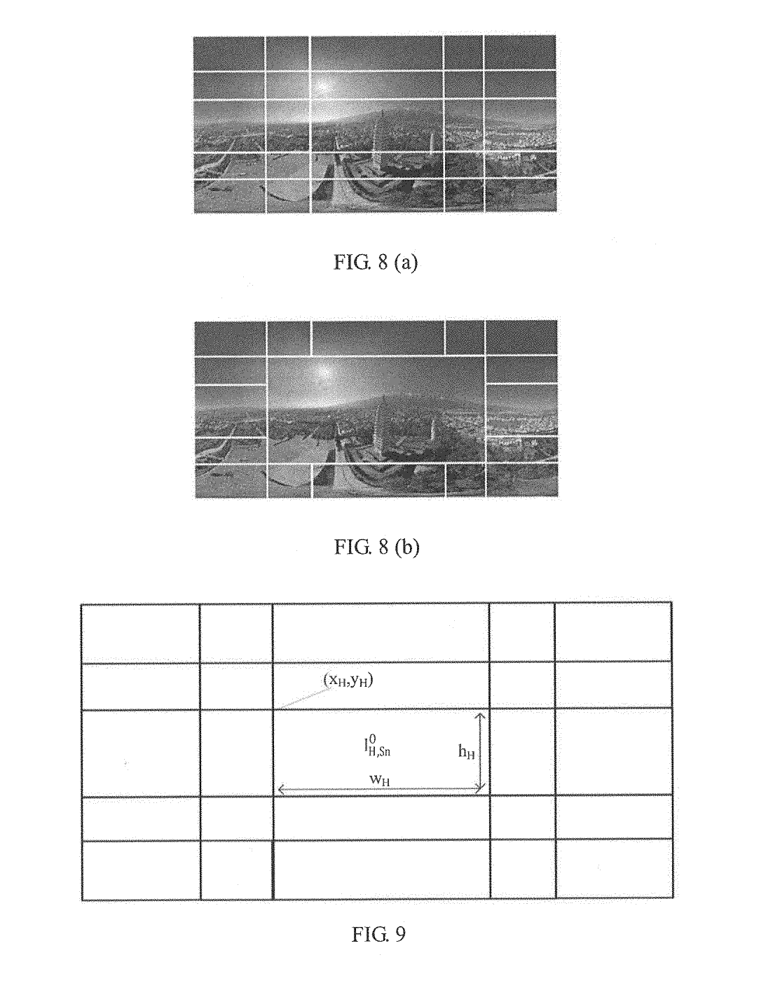

As shown in FIG. 7, the sub-images may be equal-sized image blocks. Alternatively, as shown in FIG 8 (a), the sub-images may be unequal-sized image blocks. FIG. 8 (b) shows a more flexible image block division method.

Any sub-image of the to-be-encoded image can be determined based on dimension information of the sub-image and position information of the sub-image in the to-be-encoded image.

In a feasible implementation, the dimension information and the position information of the sub-image may be represented as follows: As shown in FIG. 9, dimension information of a sub-image I_{H,Sn}^{O} is represented by using a width and a height (w_{H}, h_{H}) of the sub-image I_{H,Sn}^{O}, and position information of the sub-image I_{H,Sn}^{O} is represented by using an offset (x_{H}, y_{H}) of an upper left corner pixel position of the sub-image I_{H,Sn}^{O} relative to an upper left corner pixel position of the sub-image I_{H,Sn}^{O} in the panorama I_{H}^{O}. The width and the height of the sub-image may be measured in a basic unit of an image pixel, or a fixed-size image block, such as an image block of 4×4. A position offset of the sub-image relative to the panorama may be measured in a unit of an image pixel or a fixed-size image block, such as an image block of 4×4.

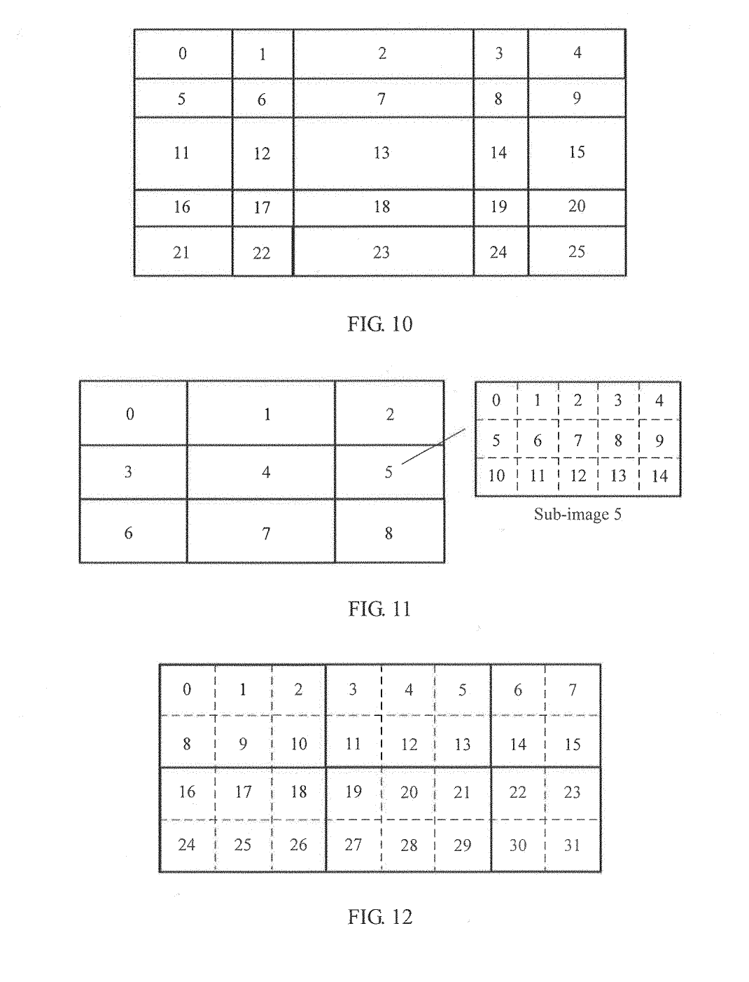

In another feasible implementation, the sub-images in the panorama may be numbered in a preset arrangement sequence, as shown in FIG. 10. Position information and dimension information of each sub-image are determined by using both panorama division information and sub-image serial number information. For example, in FIG 10, heights of a first sub-image row and a second sub-image row are 64 pixels and 64 pixels, and widths of a first sub-image column, a second sub-image column, and a third sub-image column are respectively 256, 128, 512 pixels. Therefore, position information of a sub-image with a serial number of 7 is x_{H}=256+128=384 and y_{H}=64, and dimension information of the sub-image is w_{H}=512 and h_{H}=64.

In a feasible implementation, a sub-image includes a coding unit. The sub-image includes at least one coding unit, and a coding unit includes at least one basic coding unit. The basic coding unit is a basic unit for encoding or decoding an image, and includes pixels of a preset quantity and distribution. For example, the coding unit may be a rectangular image block of 256×256 pixels, and the basic coding unit may be a rectangular image block of 16×16 or 64×256 or 256×128 pixels, and no limitation is imposed. In some video image encoding standards, the basic coding unit may be further divided into smaller prediction units, and the smaller prediction units are used as basic units for predictive coding. For example, a prediction unit may be a rectangular image block of 4×4 or 16×8 or 64×256 pixels, and no limitation is imposed.

In a feasible implementation, a manner of determining a coding unit in a sub-image is shown in FIG. 11. For example, a rectangular image block with a serial number 7 in a sub-image 5 is a coding unit with dimension information of (w_{B},h_{B}), and position information of the rectangular image block in the sub-image 5 is (2w_{B},h_{B}). With reference to position information (x_{HS},y_{BS}) of the sub-image 5, it may be determined that an offset of the coding unit 7 in the panorama is (x_{HS}+2w_{B},y_{BS}+h_{B}).

In a feasible implementation, a manner of determining a basic coding unit in a sub-image is shown in FIG. 12. A boundary of a sub-image is represented by a solid line, and a boundary of a coding unit is represented by a dashed line. For example, all coding units in the panorama may be numbered in a given sequence, and position information of the coding units in the panorama is determined through encoding.

In a feasible implementation, the dimension information of the sub-image and the position information of the sub-image in the panorama need to be encoded and transmitted to the decoder. The dimension information and the position information may be referred to as auxiliary information. In a feasible implementation, dimension information and position information of a basic coding unit or a coding unit in a sub-image are used as auxiliary information, to represent the dimension information and the position information of the sub-image. For example, the position information of the sub-image may be position information of a coding unit in an upper left corner of the sub-image, and the dimension information of the sub-image may be determined by a quantity of rows and a quantity of columns occupied by coding units in the sub-image.

A method for generating the high-resolution image bitstream may be any video or image compression and encoding method in step S602. A method the same as S602 may be used, or a method different from S602 may be used, and no limitation is imposed.

For example, in a feasible implementation, a predictive coding method is used, to generate the high-resolution image bitstream including the at least one sub-image.

S6031. Perform mapping on auxiliary information of the at least one sub-image based on a resolution ratio, to determine dimension information of a low-resolution sub-image corresponding to the at least one sub-image in the low-resolution reconstructed image and position information of the low-resolution sub-image in the low-resolution reconstructed image.

Specifically, a corresponding image area I_{L,Sn}^{R} of the sub-image I_{H,Sn}^{O} in the encoded reconstructed image I_{L}^{R} of the low-resolution panorama I_{L}^{O} is obtained based on the position information and the dimension information of the sub-image I_{H,Sn}^{O}. The offset (x_{H}, y_{H}) and the dimension (w_{H}, h_{H}) of the sub-image I_{H,Sn}^{O} may be reduced based on the downsampling multiple ratio in step S601, to obtain an offset (x_{L},y_{L}) and a dimension (w_{L}, h_{L}) of I_{L,Sn}^{R} in I_{L}^{R}, so as to obtain I_{L,Sn}^{R}.

S6032. Perform upsampling on the low-resolution sub-image based on the resolution ratio, to obtain a predictor of the at least one sub-image.

Specifically, a resolution increase operation is performed on I_{L,Sn}^{R}, to obtain a predicted sub-image I_{L2H,Sn}^{R} with a resolution the same as that of the current sub-image I_{H,Sn}^{O}. For example, an image upsampling method may be used to implement the resolution increase operation. Similar to an image downsampling process, the upsampling operation may be performed by using any interpolation filter. For example, various interpolation filters such as a bilinear filter and a bicubic filter may be used, and details are not described again.

S6033. Obtain a residual value of the at least one sub-image based on the predictor and an original pixel value of the at least one sub-image, and encode the residual value, to generate the high-resolution image bitstream.

Specifically, predictive coding is performed on the sub-image I_{H,Sn}^{O} by using a predicted sub-image I_{L2H,Sn}^{R}, to generate a compressed bitstream of I_{H,Sn}^{O}. Because the predicted sub-image I_{L2H,Sn}^{R} is obtained by performing upsampling on a corresponding image area of the sub-image I_{H,Sn}^{O} in I_{L}^{R}, a pixel value in I_{L2H,Sn}^{R} may be directly used as a predictor of a pixel value in a corresponding position in I_{H,Sn}^{O}, a difference between the predictor and an original pixel value of the sub-image I_{H,Sn}^{O} is derived, to obtain residual values of all pixels in I_{H,Sn}^{O}, and then the residual values are encoded to generate the compressed bitstream, namely, a high-resolution image bitstream, of I_{H,Sn}^{O}. The predictive coding operation may be performed by using the sub-image I_{H,Sn}^{O} as a whole, or the predictive coding operation may be selectively performed on each coding unit in the sub-image I_{H,Sn}^{O} in a unit of a coding unit. In a feasible implementation, the predictive coding may be further selectively performed on at least one basic coding unit in the coding unit. In a feasible implementation, the predictive coding may be further selectively performed on at least one prediction unit in a basic coding unit.

S604. Encode the auxiliary information of the at least one sub-image into the high-resolution image bitstream.

In a feasible implementation, when the auxiliary information includes a position offset of an upper left corner pixel of the sub-image relative to an upper left corner pixel of the panorama and a width and a height of the sub-image, for example, the width and the height (w_{H},h_{H}) and the offset (x_{H},y_{H}) of the sub-image shown in FIG. 9, or a serial number of the sub-image in a preset arrangement sequence in the panorama, for example, a serial number 7 of a sub-image shown in FIG. 10, it is assumed that this type of auxiliary information is first auxiliary information. The first auxiliary information is encoded into a slice header of a first slice of the sub-image that is represented by the auxiliary information and that is in the high-resolution image bitstream, and is transmitted to the decoder. It should be understood that the first auxiliary information may also be encoded in another bitstream position that represents the sub-image, and no limitation is imposed.

In a feasible implementation, when the auxiliary information includes a mode in which the panorama is divided into sub-images, it is assumed that this type of auxiliary information is second auxiliary information. The division mode is used to represent a method for dividing the panorama into the sub-images. For example, the division mode may be dividing the panorama into equal-sized sub-images shown in FIG. 7, or unequal-sized sub-images shown in FIG. 8 (a), or a more flexible division manner shown in FIG. 8 (b). Specifically, the division mode may include start and end points and a length of each longitude and latitude line, or may be an index number of a preset division mode, and no limitation is imposed. The second auxiliary information is encoded into a picture parameter set of the high-resolution image bitstream. It should be understood that the second auxiliary information may also be encoded in another bitstream position that represents an overall image attribute, and no limitation is imposed.

It should be understood that the decoder may determine a sub-image by decoding a position offset of an upper left corner pixel of the sub-image relative to the upper left corner pixel of the panorama and a width and a height of the sub-image, or may determine a sub-image by decoding a serial number of the sub-image in the preset arrangement sequence in the panorama and the mode in which the panorama is divided into the sub-images. Therefore, the first auxiliary information and the second auxiliary information may be individually used or used together in different feasible implementations.

It should be understood that, in this embodiment of the present application, in the to-be-encoded panorama, at least one sub-image is selectively encoded into the high-resolution image bitstream. Not all sub-images need to be encoded according to specific embodiments.

According to this embodiment of the present application, a part of an image is selectively encoded, and auxiliary information of the encoded part of the image is encoded into a bitstream, so that data that needs to be encoded and stored is reduced, encoding efficiency is improved, and power consumption is reduced. In addition, a low-resolution image is used as prior information for encoding a high-resolution image, so that efficiency of encoding the high-resolution image is improved.

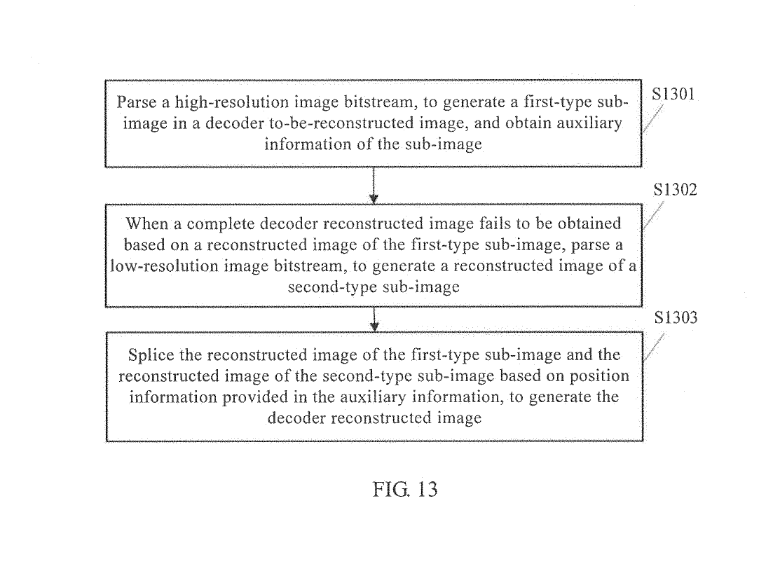

As shown in FIG. 13, an embodiment of the present application provides a video image decoding method.

As described in the video image encoding method provided in embodiments of the present application, not all sub-images in the to-be-encoded image need to be encoded and transmitted to a decoder. In a feasible implementation, not all sub-image bitstreams that are selectively encoded and transmitted by an encoder need to be forwarded to the decoder. For example, only a sub-image bitstream related to a current field of view of a user may be transmitted to the decoder. In a feasible implementation, the decoder does not need to decode all received sub-image bitstreams. For example, when a decoding capability or power consumption is limited, the decoder may choose to decode some of the received sub-image bitstreams. It is assumed that a sub-image that is in a decoder reconstructed image and that is generated by the decoder by decoding a sub-image bitstream is a first-type sub-image, and that an image part in the decoder to-be-reconstructed image other than the first-type sub-image includes a second-type sub-image. The decoder to-be-reconstructed image is a to-be-reconstructed original-resolution panorama. A sub-image bitstream is generated by the encoder by performing original-resolution encoding on a sub-image, and in comparison with an encoded bitstream that is of a low-resolution version and that is generated by the encoder, the sub-image bitstream is referred to as a high-resolution image bitstream.

S1301. Parse a high-resolution image bitstream, to generate a first-type sub-image in a decoder to-be-reconstructed image, and obtain auxiliary information of the sub-image.

Corresponding to step S603, the high-resolution image bitstream is parsed by using a decoding method corresponding to the encoding method, to generate the first-type sub-image in a to-be-decoded panorama, and the auxiliary information of the first-type sub-image is obtained by parsing the high-resolution image bitstream.

For example, in a feasible implementation, a predictive coding method is used to parse the high-resolution image bitstream, to generate a reconstructed image of a first-type sub-image.

S13011: Parse the high-resolution image bitstream, to obtain the auxiliary information and a residual value of the first-type sub-image in the decoder to-be-reconstructed image.

Corresponding to step S6033, the residual value of the sub-image may be obtained by parsing the high-resolution image bitstream. Corresponding to step S604, the auxiliary information of the sub-image is obtained through parsing in a bitstream position corresponding to the auxiliary information, and the auxiliary information may be used to determine dimension information of the sub-image and position information of the sub-image in the panorama. A specific operation process is corresponding to the encoding process in steps S6033 and S604, and details are not described again.

S13012. Perform mapping on the auxiliary information of the first-type sub-image based on a resolution ratio, to determine dimension information of a first-type low-resolution sub-image corresponding to the first-type sub-image in a low-resolution to-be-reconstructed image and position information of the first-type low-resolution sub-image in the low-resolution to-be-reconstructed image.

A manner in which the decoder knows the resolution ratio, namely, the downsampling multiple ratio, is determined in step S602. Corresponding to the encoder, in some feasible implementations, the encoder and the decoder agree on the downsampling multiple ratio without encoding or information transmission between the encoder and the decoder. In a feasible implementation, the encoded downsampling multiple ratio is decoded after transmission. For example, the downsampling multiple ratio may be obtained through parsing in a position corresponding to a slice header of a first slice in a low-resolution bitstream or a position of a picture parameter set. In a feasible implementation, a resolution of a to-be-encoded image and a resolution of a low-resolution image are respectively encoded into the high-resolution image bitstream and the low-resolution image bitstream in respective bitstream encoding processes, and the decoder may obtain the downsampling multiple ratio by separately parsing the high-resolution image bitstream and the low-resolution image bitstream and comparing a resolution of a high-resolution image and the resolution of the low-resolution image that are obtained through parsing.

After the resolution ratio is obtained, the position information and dimension information corresponding to the sub-image in the low-resolution image, namely, the position information and the dimension information of the first-type low-resolution sub-image, may be obtained with reference to the method in step S6031, and details are not described again.

S13013. Parse a low-resolution image bitstream, to generate the first-type low-resolution sub-image.

Corresponding to step S602, the low-resolution image bitstream is parsed by using a decoding method corresponding to the encoding method, and the first-type low-resolution sub-image is generated based on the dimension and position information of the first-type low-resolution sub-image that are determined in step S13012. A specific implementation method is similar to step S602, and details are not described again.

S13014. Perform upsampling on the first-type low-resolution sub-image based on the resolution ratio, to obtain a predictor of the first-type sub-image.

A specific implementation method is similar to step S6032, and details are not described again.

S13015. Generate a reconstructed image of the first-type sub-image based on the predictor and the residual value of the first-type sub-image.

Specifically, the residual value of the first-type sub-image that is obtained through parsing in step S13011 is added to the predictor obtained by performing upsampling on the low-resolution sub-image in step S13014, to obtain the reconstructed image of the first-type sub-image.

S1302. When a complete decoder reconstructed image fails to be obtained based on the reconstructed image of the first-type sub-image, parse the low-resolution image bitstream, to generate a reconstructed image of a second-type sub-image.

As described above, the auxiliary information represents the position information and the dimension information of the first-type sub-image in the decoder to-be-reconstructed image, and the first-type sub-image and the second-type sub-image jointly constitute the to-be-decoded panorama.

The position information and the dimension information of the first-type sub-image may be obtained based on the auxiliary information. After the high-resolution image bitstream is received and is parsed by the decoder, if no complete image of the to-be-reconstructed panorama is obtained based on all reconstructed images of first-type sub-images, it indicates that the to-be-reconstructed panorama further includes the second-type sub-image, and it can be determined that a position of a pixel set other than the first-type sub-image is a position of the second-type sub-image.

In this case, similar to steps S13012 to S13014, the low-resolution bitstream is parsed to obtain a second-type low-resolution sub-image of the second-type sub-image in a corresponding position of the low-resolution decoder to-be-reconstructed image, and an upsampling operation is performed on the second-type low-resolution sub-image based on the same resolution ratio, to obtain the reconstructed image of the second-type sub-image.

S1303. Splice the reconstructed image of the first-type sub-image and the reconstructed image of the second-type sub-image based on the position information provided in the auxiliary information, to generate the decoder reconstructed image.

According to this embodiment of the present application, a part of an image is selectively encoded, and auxiliary information of the encoded part of the image is encoded into a bitstream; and at the decoder, a low-resolution image obtained through upsampling is used to fill a reconstructed image part that is in the decoder to-be-reconstructed image and that has not been generated, so that data that needs to be encoded and stored is reduced, encoding efficiency is improved, and power consumption is reduced. In addition, a low-resolution image is used as prior information for encoding a high-resolution image, so that efficiency of encoding the high-resolution image is improved.

In a feasible implementation, the decoder may parse the low-resolution bitstream based on an entire image, to generate the low-resolution reconstructed image. Specifically, a video image decoding method may be as follows:

S1201. Parse a low-resolution image bitstream, to generate a low-resolution reconstructed image.

S1202. Parse a high-resolution image bitstream, to generate a first-type sub-image in a decoder to-be-reconstructed image, and obtain auxiliary information of the sub-image.

S1202 includes the following steps:

S12021. Parse the high-resolution image bitstream, to obtain auxiliary information and a residual value of the first-type sub-image in the decoder to-be-reconstructed image.

S12022. Perform mapping on the auxiliary information of the first-type sub-image based on a resolution ratio, to determine dimension information of a first-type low-resolution sub-image corresponding to the first-type sub-image in the low-resolution reconstructed image and position information of the first-type low-resolution sub-image in the low-resolution reconstructed image.

S12023. Perform upsampling on the first-type low-resolution sub-image based on the resolution ratio, to obtain a predictor of the first-type sub-image.

S12024. Generate a reconstructed image of the first-type sub-image based on the predictor and the residual value of the first-type sub-image.

S1203. When a complete decoder reconstructed image fails to be obtained based on the reconstructed image of the first-type sub-image, generate a reconstructed image of a second-type sub-image based on the low-resolution reconstructed image.

S1204. Splice the reconstructed image of the first-type sub-image and the reconstructed image of the second-type sub-image based on the position information provided in the auxiliary information, to generate the decoder reconstructed image.

In a feasible implementation, upsampling may alternatively be performed on the generated low-resolution reconstructed image after step S1201, for use in subsequent steps.

According to this embodiment of the present application, a part of an image is selectively encoded, and auxiliary information of the encoded part of the image is encoded into a bitstream; and at the decoder, a low-resolution image obtained through upsampling is used to fill a reconstructed image part that is in the decoder to-be-reconstructed image and that has not been generated, so that data that needs to be encoded and stored is reduced, encoding efficiency is improved, and power consumption is reduced. In addition, a low-resolution image is used as prior information for encoding a high-resolution image, so that efficiency of encoding the high-resolution image is improved.

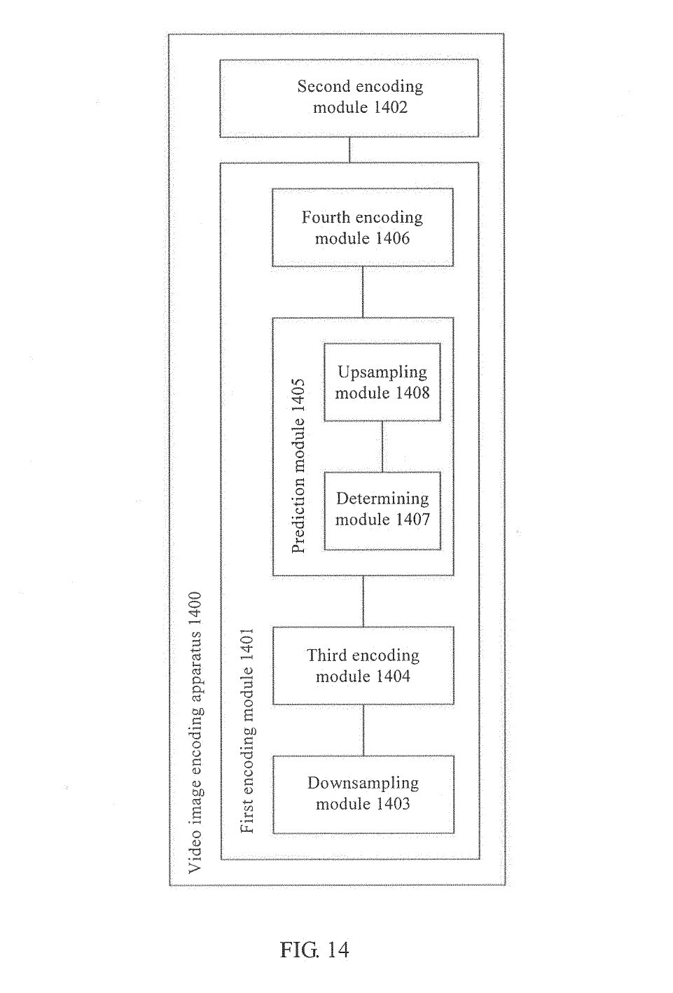

As shown in FIG. 14, an embodiment of the present application provides a video image encoding apparatus 1400, including:

a first encoding module 1401, configured to encode at least one sub-image of a to-be-encoded image, to generate a high-resolution image bitstream, where the sub-image is a pixel set of any continuous area in the to-be-encoded image, and sub-images of the to-be-encoded image do not overlap with each other; and

a second encoding module 1402, configured to encode auxiliary information of the at least one sub-image into the high-resolution image bitstream, where the auxiliary information represents dimension information of the sub-image and position information of the sub-image in the to-be-encoded image. The second encoding module 1402 may specifically perform step S604.

The first encoding module 1401 includes:

a downsampling module 1403, configured to perform downsampling on the to-be-encoded image, to generate a low-resolution image, where the downsampling module 1403 may specifically perform step S601;

a third encoding module 1404, configured to encode the low-resolution image, to generate a low-resolution image bitstream and a low-resolution reconstructed image, where the third encoding module 1404 may specifically perform step S602;

a prediction module 1405, configured to obtain a predictor of the at least one sub-image based on the low-resolution reconstructed image, a resolution ratio between the to-be-encoded image and the low-resolution image, and the auxiliary information of the at least one sub-image; and

a fourth encoding module 1406, configured to: obtain a residual value of the at least one sub-image based on the predictor and an original pixel value of the at least one sub-image, and encode the residual value, to generate the high-resolution image bitstream, where the fourth encoding module 1406 may specifically perform step S6033.

The prediction module 1405 includes:

a determining module 1407, configured to perform mapping on the auxiliary information of the at least one sub-image based on the resolution ratio, to determine dimension information of a low-resolution sub-image corresponding to the at least one sub-image in the low-resolution reconstructed image and position information of the low-resolution sub-image in the low-resolution reconstructed image, where the determining module 1407 may specifically perform step S6031; and

an upsampling module 1408, configured to perform upsampling on the low-resolution sub-image based on the resolution ratio, to obtain the predictor of the at least one sub-image, where the upsampling module 1408 may specifically perform step S6032.

According to this embodiment of the present application, a part of an image is selectively encoded, and auxiliary information of the encoded part of the image is encoded into a bitstream, so that data that needs to be encoded and stored is reduced, encoding efficiency is improved, and power consumption is reduced. In addition, a low-resolution image is used as prior information for encoding a high-resolution image, so that efficiency of encoding the high-resolution image is improved.

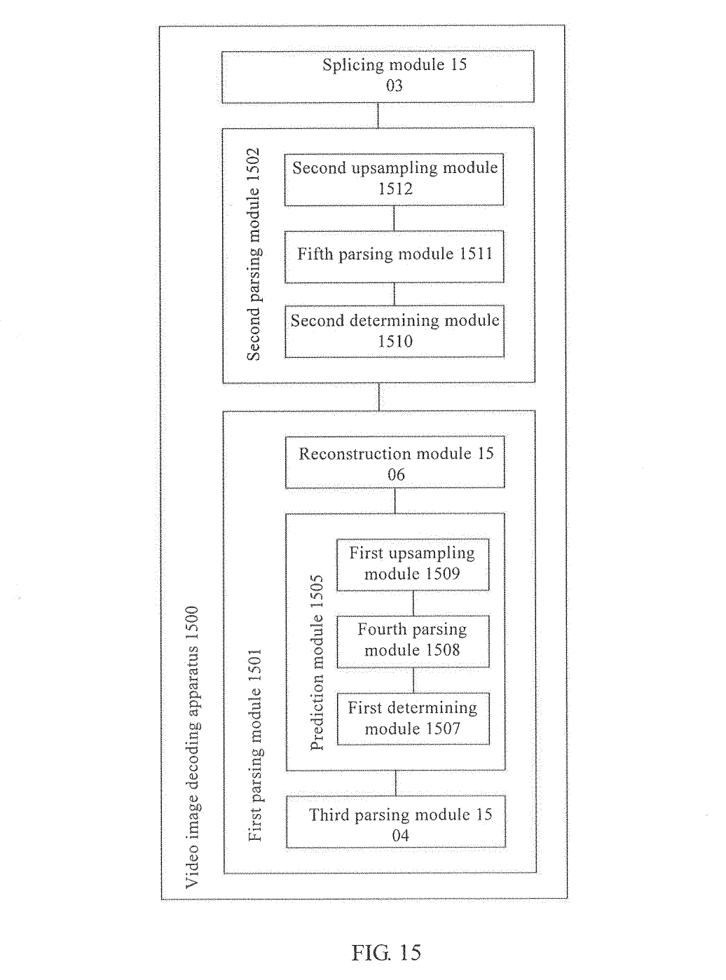

As shown in FIG. 15, an embodiment of the present application provides a video image decoding apparatus 1500, including:

a first parsing module 1501, configured to parse a high-resolution image bitstream, to generate a reconstructed image of a first-type sub-image and auxiliary information of the first-type sub-image, where the auxiliary information represents dimension information of the sub-image and position information of the sub-image in a decoder to-be-reconstructed image, the sub-image is a pixel set of any continuous area in the decoder to-be-reconstructed image, and sub-images of the decoder to-be-reconstructed image do not overlap with each other;

a second parsing module 1502, configured to: when a complete decoder reconstructed image fails to be obtained based on the reconstructed image of the first-type sub-image, parse a low-resolution image bitstream, to generate a reconstructed image of a second-type sub-image, where the second-type sub-image has a resolution the same as that of the first-type sub-image; and

a splicing module 1503, configured to splice the reconstructed image of the first-type sub-image and the reconstructed image of the second-type sub-image based on the auxiliary information, to generate the decoder reconstructed image, where the splicing module 1503 may specifically perform step S1303.

The first parsing module 1501 includes:

a third parsing module 1504, configured to parse the high-resolution image bitstream, to obtain the auxiliary information and a residual value of the first-type sub-image in the decoder to-be-reconstructed image, where the third parsing module 1504 may specifically perform step S13011;

a prediction module 1505, configured to obtain a predictor of the first-type sub-image based on the low-resolution bitstream, a resolution ratio between the decoder to-be-reconstructed image and a low-resolution to-be-reconstructed image, and the auxiliary information of the first-type sub-image; and

a reconstruction module 1506, configured to generate the reconstructed image of the first-type sub-image based on the predictor and the residual value of the first-type sub-image, where the reconstruction module 1506 may specifically perform step S13015.

The prediction module 1505 includes:

a first determining module 1507, configured to perform mapping on the auxiliary information of the first-type sub-image based on the resolution ratio, to determine dimension information of a first-type low-resolution sub-image corresponding to the first-type sub-image in the low-resolution to-be-reconstructed image and position information of the first-type low-resolution sub-image in the low-resolution to-be-reconstructed image, where the first determining module 1507 may specifically perform step S13012;

a fourth parsing module 1508, configured to parse the low-resolution image bitstream, to generate the first-type low-resolution sub-image, where the fourth parsing module 1508 may specifically perform step S13013; and

a first upsampling module 1509, configured to perform upsampling on the first-type low-resolution sub-image based on the resolution ratio, to obtain the predictor of the first-type sub-image, where the first upsampling module 1509 may specifically perform step S13014.

The second passing module 1502 includes:

a second determining module 1510, configured to determine, based on the auxiliary information of the first-type sub-image and the resolution ratio between the decoder to-be-reconstructed image and the low-resolution to-be-reconstructed image, dimension information of a second-type low-resolution sub-image corresponding to the second-type sub-image in the low-resolution to-be-reconstructed image and position information of the second-type low-resolution sub-image in the low-resolution to-be-reconstructed image, where the second determining module 1510 may specifically perform step S1302;

a fifth parsing module 1511, configured to parse the low-resolution image bitstream, to generate the second-type low-resolution sub-image, where the fifth parsing module 1511 may specifically perform step S1302; and

a second upsampling module 1512, configured to perform upsampling on the second-type low-resolution sub-image based on the resolution ratio, to generate the reconstructed image of the second-type sub-image, where the second upsampling module 1512 may specifically perform step S1302.

According to this embodiment of the present application, a part of an image is selectively encoded, and auxiliary information of the encoded part of the image is encoded into a bitstream; and at the decoder, a low-resolution image obtained through upsampling is used to fill a reconstructed image part that is in the decoder to-be-reconstructed image and that has not been generated, so that data that needs to be encoded and stored is reduced, encoding efficiency is improved, and power consumption is reduced. In addition, a low-resolution image is used as prior information for encoding a high-resolution image, so that efficiency of encoding the high-resolution image is improved.

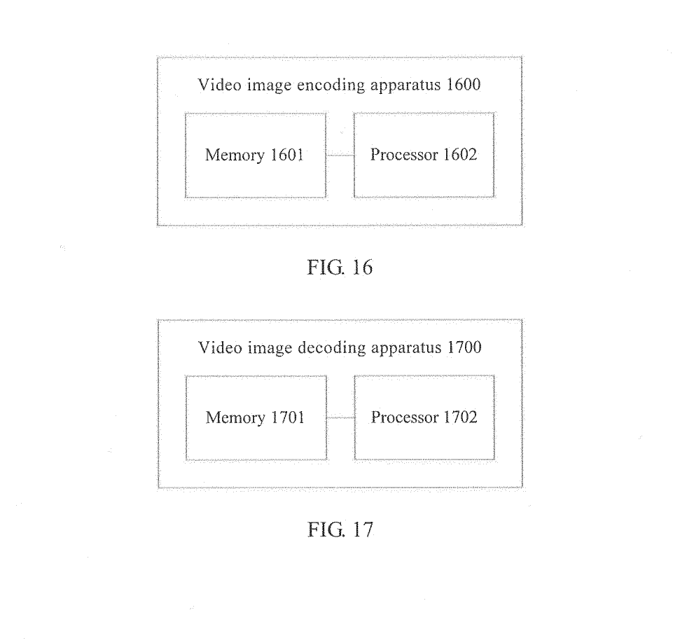

As shown in FIG. 16, an embodiment of the present application provides a video image encoding apparatus 1600, including a memory 1601 and a processor 1602 coupled to the memory. The memory is configured to store code and an instruction. The processor is configured to perform the following steps according to the code and the instruction: encoding at least one sub-image of a to-be-encoded image, to generate a high-resolution image bitstream, where the sub-image is a pixel set of any continuous area in the to-be-encoded image, and sub-images of the to-be-encoded image do not overlap with each other; and encoding auxiliary information of the at least one sub-image into the high-resolution image bitstream, where the auxiliary information represents dimension information of the sub-image and position information of the sub-image in the to-be-encoded image. The processor is specifically configured to: perform downsampling on the to-be-encoded image, to generate a low-resolution image; encode the low-resolution image, to generate a low-resolution image bitstream and a low-resolution reconstructed image; obtain a predictor of the at least one sub-image based on the low-resolution reconstructed image, a resolution ratio between the to-be-encoded image and the low-resolution image, and the auxiliary information of the at least one sub-image; and obtain a residual value of the at least one sub-image based on the predictor and an original pixel value of the at least one sub-image, and encode the residual value, to generate the high-resolution image bitstream.

As shown in FIG. 17, an embodiment of the present application provides a video image decoding apparatus 1700, including a memory 1701 and a processor 1702 coupled to the memory. The memory is configured to store code and an instruction. The processor is configured to perform the following steps according to the code and the instruction: parsing a high-resolution image bitstream, to generate a reconstructed image of a first-type sub-image and auxiliary information of the first-type sub-image, where the auxiliary information represents dimension information of the sub-image and position information of the sub-image in a decoder to-be-reconstructed image, the sub-image is a pixel set of any continuous area in the decoder to-be-reconstructed image, and sub-images of the decoder to-be-reconstructed image do not overlap with each other; when a complete decoder reconstructed image fails to be obtained based on the reconstructed image of the first-type sub-image, parsing a low-resolution image bitstream, to generate a reconstructed image of a second-type sub-image, where the second-type sub-image has a resolution the same as that of the first-type sub-image; and splicing the reconstructed image of the first-type sub-image and the reconstructed image of the second-type sub-image based on the auxiliary information, to generate the decoder reconstructed image.

According to this embodiment of the present application, a part of an image is selectively encoded, and auxiliary information of the encoded part of the image is encoded into a bitstream; and at the decoder, a low-resolution image obtained through upsampling is used to fill a reconstructed image part that is in the decoder to-be-reconstructed image and that has not been generated, so that data that needs to be encoded and stored is reduced, encoding efficiency is improved, and power consumption is reduced. In addition, a low-resolution image is used as prior information for encoding a high-resolution image, so that efficiency of encoding the high-resolution image is improved.

It may be clearly understood by a person skilled in the art that, for the purpose of convenient and brief description, division of the foregoing function modules is used as an example for illustration. In actual application, the foregoing functions can be allocated to different function modules and implemented based on a requirement, that is, an inner structure of an apparatus is divided into different function modules to implement all or some of the functions described above. For a detailed working process of the foregoing system, apparatus, and unit, refer to a corresponding process in the foregoing method embodiments, and details are not described herein again.

In the several embodiments provided in this application, it should be understood that the disclosed system, apparatus, and method may be implemented in other manners. For example, the described apparatus embodiment is merely an example. For example, the module or unit division is merely logical function division and may be other division in actual implementation. For example, a plurality of units or components may be combined or integrated into another system, or some features may be ignored or not performed. In addition, the displayed or discussed mutual couplings or direct couplings or communication connections may be implemented through some interfaces. The indirect couplings or communication connections between the apparatuses or units may be implemented in electronic or other forms.

The units described as separate parts may or may not be physically separate, and parts displayed as units may or may not be physical units, may be located in one position, or may be distributed on a plurality of network units. Some or all of the units may be selected based on actual requirements to achieve objectives of solutions of embodiments of the present application.

In addition, functional units in embodiments of the present application may be integrated into one processing unit, or each of the units may exist alone physically, or two or more units are integrated into one unit. The integrated unit may be implemented in a form of a software function unit.

When the integrated unit is implemented in the form of a software functional unit and sold or used as an independent product, the integrated unit may be stored in a computer-readable storage medium. Based on such an understanding, all or some of the technical solutions may be implemented in a form of a software product. The software product is stored in a storage medium, and includes several instructions for instructing a computer device (which may be a personal computer, a server, or a network device) or a processor to perform all or some of the steps of the methods described in embodiments of the present application. The storage medium is a non-transitory medium, and includes any medium that can store program code, such as a flash memory, a removable hard disk, a read-only memory, a random access memory, a magnetic disk, or an optical disc.

The foregoing are merely example embodiments of the present application. A person skilled in the art may make various modifications and variations to the present application without departing from the spirit and scope of the present application. A person of ordinary skill in the art may understand that embodiments or characteristics of different embodiments can be combined into a new embodiment under the condition of no conflicts.

What is claimed is:

1. A video image encoding method, comprising:
encoding, by a processor, at least one sub-image of a to-be-encoded image to generate a high-resolution image bitstream, wherein a sub-image of the at least one sub-image is a pixel set of any continuous area in the to-be-encoded image, and sub-images of the to-be-encoded image do not overlap with each other; and
encoding, by the processor, auxiliary information of the at least one sub-image into the high-resolution image bitstream, wherein the auxiliary information represents dimension information of the at least one sub-image and position information of the at least one sub-image in the to-be-encoded image.

2. The method according to claim 1, wherein encoding the at least one sub-image of the to-be-encoded image to generate the high-resolution image bitstream comprises:
performing downsampling on the to-be-encoded image to generate a low-resolution image;
encoding the low-resolution image to generate a low-resolution reconstructed image;
obtaining a predictor of the at least one sub-image based on the low-resolution reconstructed image, a resolution ratio between the to-be-encoded image and the low-resolution image, and the auxiliary information of the at least one sub-image; and
obtaining a residual value of the at least one sub-image based on the predictor and an original pixel value of the at least one sub-image, and encoding the residual value, to generate the high-resolution image bitstream.

3. The method according to claim 2, wherein obtaining the predictor of the at least one sub-image further comprises:
performing mapping on the auxiliary information of the at least one sub-image based on the resolution ratio to determine dimension information of a low-resolution sub-image corresponding to the at least one sub-image in the low-resolution reconstructed image and position information of the low-resolution sub-image in the low-resolution reconstructed image; and
performing upsampling on the low-resolution sub-image based on the resolution ratio to obtain the predictor of the at least one sub-image.

4. The method according to claim 1, wherein the auxiliary information comprises: a position offset of an upper left corner pixel of the at least one sub-image relative to an upper left corner pixel of the to-be-encoded image and a width and a height of the at least one sub-image, or a serial number of the at least one sub-image in a preset arrangement sequence in the to-be-encoded image.

5. The method according to claim 4, wherein a slice header of a first slice of the at least one sub-image in the high-resolution image bitstream carries the auxiliary information.

6. The method according to claim 1, wherein the auxiliary information further comprises a mode in which the to-be-encoded image is divided into the sub-image.

7. The method according to claim 6, wherein a picture parameter set of the high-resolution image bitstream carries the auxiliary information.

8. The method according to claim 2, wherein the resolution ratio is a preset value.

9. A video image decoding method, comprising:
parsing, by a processor, a high-resolution image bitstream to generate a reconstructed image of a first-type sub-image and auxiliary information of the first-type sub-image, wherein the auxiliary information represents dimension information of the first-type sub-image and position information of the first-type sub-image in a to-be-reconstructed image, the first-type sub-image is a pixel set of a continuous area in the to-be-reconstructed image, and sub-images of the to-be-reconstructed image do not overlap with each other;
when the processor fails to obtain a complete reconstructed image based on the reconstructed image of the first-type sub-image, parsing, by the processor, a low-resolution image bitstream to generate a reconstructed image of a second-type sub-image, wherein the second-type sub-image has a same resolution as that of the first-type sub-image; and
splicing the reconstructed image of the first-type sub-image and the reconstructed image of the second-type sub-image based on the auxiliary information to generate the complete reconstructed image.

10. The method according to claim 9, wherein parsing the high-resolution image bitstream to generate the reconstructed image of the first-type sub-image and the auxiliary information of the first-type sub-image comprises:
parsing the high-resolution image bitstream to obtain the auxiliary information and a residual value of the first-type sub-image in the to-be-reconstructed image;
obtaining a predictor of the first-type sub-image based on the low-resolution image bitstream, a resolution ratio between the to-be-reconstructed image and a low-resolution to-be-reconstructed image, and the auxiliary information of the first-type sub-image; and
generating the reconstructed image of the first-type sub-image based on the predictor and the residual value of the first-type sub-image.

11. The method according to claim 10, wherein obtaining the predictor of the first-type sub-image comprises:
performing mapping on the auxiliary information of the first-type sub-image based on the resolution ratio to determine dimension information of a first-type low-resolution sub-image corresponding to the first-type sub-image in the low-resolution to-be-reconstructed image and position information of the first-type low-resolution sub-image in the low-resolution to-be-reconstructed image;
parsing the low-resolution image bitstream to generate the first-type low-resolution sub-image; and
performing upsampling on the first-type low-resolution sub-image based on the resolution ratio to obtain the predictor of the first-type sub-image.

12. The method according to claim 9, wherein parsing the low-resolution image bitstream to generate the reconstructed image of the second-type sub-image comprises:
determining, based on the auxiliary information of the first-type sub-image and the resolution ratio between the to-be-reconstructed image and the low-resolution to-be-reconstructed image, dimension information of a second-type low-resolution sub-image corresponding to the second-type sub-image in the low-resolution to-be-reconstructed image and position information of the second-type low-resolution sub-image in the low-resolution to-be-reconstructed image;
parsing the low-resolution image bitstream to generate the second-type low-resolution sub-image; and
performing upsampling on the second-type low-resolution sub-image based on the resolution ratio to generate the reconstructed image of the second-type sub-image.

13. The method according to claim 9, wherein the auxiliary information comprises: a position offset of an upper left corner pixel of the first-type sub-image relative to an upper left corner pixel of the to-be-reconstructed image and a width and a height of the first-type sub-image, or a serial number of the first-type sub-image in a preset arrangement sequence in the to-be-reconstructed image.

14. The method according to claim 13, wherein a slice header of a first slice of the first-type sub-image in the high-resolution image bitstream carries the auxiliary information.

15. The method according to claim 9, wherein the auxiliary information further comprises a mode in which the to-be-reconstructed image is divided into sub-images.

16. The method according to claim 15, wherein a picture parameter set of the high-resolution image bitstream carries the auxiliary information.

17. The method according to claim 10, wherein the resolution ratio is a preset value.

18. The method according to claim 10, further comprising:
parsing a slice header of a first slice or a picture parameter set of the low-resolution image bitstream to obtain the resolution ratio.

19. The method according to claim 10, further comprising:
parsing the high-resolution image bitstream to obtain a resolution of the to-be-reconstructed image; and
parsing the low-resolution image bitstream to obtain a resolution of the low-resolution to-be-reconstructed image.
20. A video image decoding apparatus, comprising:
a memory; and
a processor coupled to the memory;
wherein the memory is configured to processor-executable instructions; and
wherein the processor is configured to execute the processor-executable instructions to facilitate:
parsing a high-resolution image bitstream to generate a reconstructed image of a first-type sub-image and auxiliary information of the first-type sub-image, wherein the auxiliary information represents dimension information of the first-type sub-image and position information of the first-type sub-image in a to-be-reconstructed image, the first-type sub-image is a pixel set of a continuous area in the to-be-reconstructed image, and sub-images of the to-be-reconstructed image do not overlap with each other; and
when obtaining a complete reconstructed image based on the reconstructed image of the first-type sub-image fails, parsing a low-resolution image bitstream to generate a reconstructed image of a second-type sub-image, wherein the second-type sub-image has a same resolution as that of the first-type sub-image; and splicing the reconstructed image of the first-type sub-image and the reconstructed image of the second-type sub-image based on the auxiliary information to generate the complete reconstructed image.
